(19) United States
(12) Patent Application Publication
(10) Pub. No.: US 2009/0197567 A1
(43) Pub. Date: Aug. 6, 2009

(54) Emergency call from a cell phone

(76) Inventor: Mark Ellery Ogram, Tucson, AZ (US)

Correspondence Address: Mark E. Ogram, Ste. 110-186, 6990 E. 22nd Street, Tucson, AZ, 85710-5192, US

(21) Appl. No.: 12/012,402

(22) Filed: Feb. 1, 2008

(51) Int. Cl. H04M 11/04

(52) U.S. Cl. 455/404.2

(57) ABSTRACT

The invention provides a portable communications apparatus which is useful for reporting positional status report to a user-selected recipient(s). Using a global-positioning-receiver (i.e. GPS) to generate a location indicia of the portable communications apparatus, and a pre-defined user-generated message with at least one user-defined recipient, the apparatus, when activated by the user, sends the user-defined message, together with the location information, to the user-defined recipient. This information is useful for alerting the recipient of the user's location or to notify the recipient that assistance is needed.

### BACKGROUND OF THE INVENTION

This invention relates generally to emergency calls or status reports from cell phones and the like.

Cell phones have become ubiquitous in modern society. They allow the user to contact others with voice information, to receive information, and to gather information (i.e. maps) for the user. In fact, it is now uncommon for someone to be without a cell phone.

The empowerment that the cell phone gives, and the security or protection that user is able to derive from it, allows people to venture into new areas with the assurance that “help” is only a phone call away. Using “9-1-1” a caller is able to contact emergency personnel to request a variety of emergency assistance.

The same sort of voice controlled, and even automatic assistance, is available through a variety of service providers such as “ON-STAR”. These types of service providers allow a manual activation (and also automatic activation) which reports the vehicle's position (as obtained from the Global Positioning System (“GPS”) to the service provider so that emergency personnel can be notified.

GPS is not unique to these type of service providers. Rather, GPS and the associated mapping capability, is found in a variety of devices including cell phones. Such a system is described in U.S. Pat. No. 7,312,700, entitled “GPS Enabled Cell Phone with Common Interest Alerts” issued to Karaguz et al. on Dec. 25, 2007, incorporated hereinto by reference.

It is clear that the cell phone has a variety of applications and continues to become an ever more useful tools for society.

### SUMMARY OF THE INVENTION

The invention provides a portable communications apparatus which is useful for reporting positional status response to user selected recipient(s). While the present invention contemplates its use with a service provider, such as an emergency assistance facilitator, the invention's more prominent role is to empower the user by allowing the user to define who is to receive the message. Even the message itself is defined by the user.

The user-defined message, when it is sent, contains not only the message, but the location information as well.

Using a positioning receiver, such as GPS, the apparatus is able to automatically identify its own location. This information, usually in latitude and longitude coordinates or another type of location identifier, provides the recipient with expanded and useful information. Those of ordinary skill in the art readily recognize a variety of implementations of GPS into cell phones, including, but not limited to: U.S. Pat. No. 7,312,712, entitled “Traveler Safety Notification System” issued to Worrall on Dec. 25, 2007; and, U.S. Pat. No. 7,312,697, entitled “Method of Using Telematic Units to Place Courtesy Notifications” issued to Veliu et al., both of which are incorporated hereinto by reference.

The latitude/longitude of the GPS is readily transformed into maps and actual addresses through a variety of techniques well known to those of ordinary skill in the art.

In practice, for the preferred embodiment of the invention, the user establishes the message which they want sent. Such a message may denote an emergency, such as:
“Dad, had car trouble. Please come. I'm at . . . ”
   or may be a simple status message, such as:
“Getting closer to your house, now at . . . ”

The user is then able to denote where these messages will be sent. In the emergency message above, the recipient would be the father's e-mail address and instant message address. In the status message above, the message might be the instant message address for the individual who is at the final destination.

In either case, it is the user of the portable apparatus or cell phone, who defines who is to receive the message.

In some embodiments of the invention, there may be a pre-defined recipient for the emergency message such as a service provider for emergency services.

These messages remain inactive and stored in the memory of the cell phone or portable apparatus until activated by the user. Often these message is stored in memory (such as Random Access Memory, “RAM”) for an hour or more before being called into use.

Activation is ideally through the “pressing” of a single button. This encourages the use of the messaging system without placing any real operating burden on the user.

In another version, the message system is activated when an emergency phone call (i.e. 9-1-1) is activated. This provides backup and notification to the designated receiver. As example, when the user dials 9-1-1, not only are they connected to the appropriate emergency facility, but, a message such as the following may be sent:
“Emergency call sent out by your daughter from 5678 Oak Drive”

The system lies dormant until the user activates it. When activated by the user, the system combines the user-defined message with the location information (sometimes with the GPS coordinates), and sends the completed message to the user-defined recipient. In this manner, the user of the apparatus is in total control of: the message's content; when the message is sent; and who receives the message.

Communication of the completed message is using any of a variety of techniques well known to those of ordinary skill in the art. Examples of such communications mechanisms are described in U.S. Pat. No. 7,308,247, entitled “Cellular Telephone Safety System” issued to Thompson et al. on Dec. 11, 2007; and, U.S. Pat. No. 7,315,747, entitled “Handheld Electronic Device and Associated Method Providing Availability Data in a Messaging Environment” issued to Klassen et al. on Jan. 1, 2008, both of which are incorporated hereinto by reference.

In some embodiments of the invention, the message is expanded to include a map showing the location of the apparatus (based upon the GPS information) or an approximate address of the location. Using the example of the contact message above, the resulting message may then become:
“Dad, had car trouble. Please come. I'm at 1234 Main Street, Tucson, Ariz.”

In the case where a simple status message is appropriate, then the completed message could be:
“On our way to California, we are now at 124 Main Street, Tucson, Ariz. (Latitude/Longitude)”

This capability allows the cell phones (or other portable device) to communicate a completed message at the pressing of a single button.

The invention, together with various embodiments thereof, will be more fully explained by the following descriptions of the attached drawings.

### DRAWINGS IN SUMMARY

FIGS. 1A and 1B are transparent views and covered views of the preferred portable communications apparatus of this invention.

FIG. 2 graphically illustrates the components of the system of which the portable communications apparatus interacts.

FIGS. 3A and 3B is a flowchart and message structure for the creation of the stored message string within the portable communications apparatus.

FIG. 4 is a flowchart of the operation of the preferred messaging system for the portable communications apparatus.

FIG. 5 is a flowchart of the operation of the receiver/transmitter of the preferred embodiment.

### DRAWINGS IN DETAIL

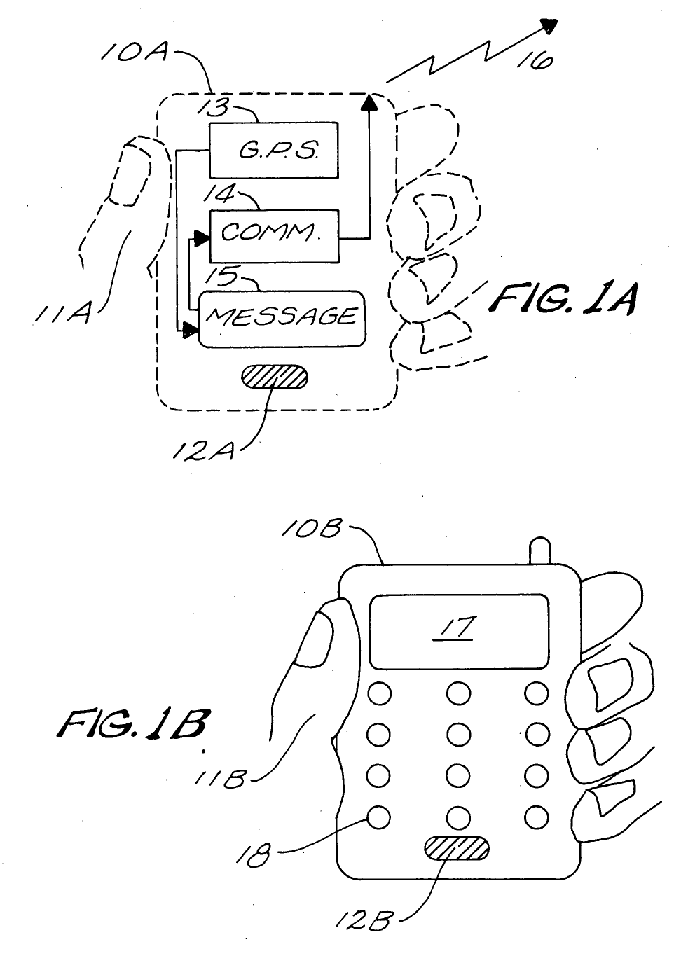

FIGS 1A and 1B are transparent views and covered views of the preferred portable communications apparatus of this invention.

Referring to FIG. 1A, the transparent view of the preferred portable communications apparatus, operator 11A holds the communications apparatus 10A in his hand. Communications apparatus 10A is any of many different devices well known to those of ordinary skill in the art and include such items as cellular phones, walkie talkies, and palm held computers.

Within communications apparatus 10A is a GPS receiver 13 which uses satellite generated positional signals to generate indicia of the latitude and longitude of the position of the communications apparatus 10A.

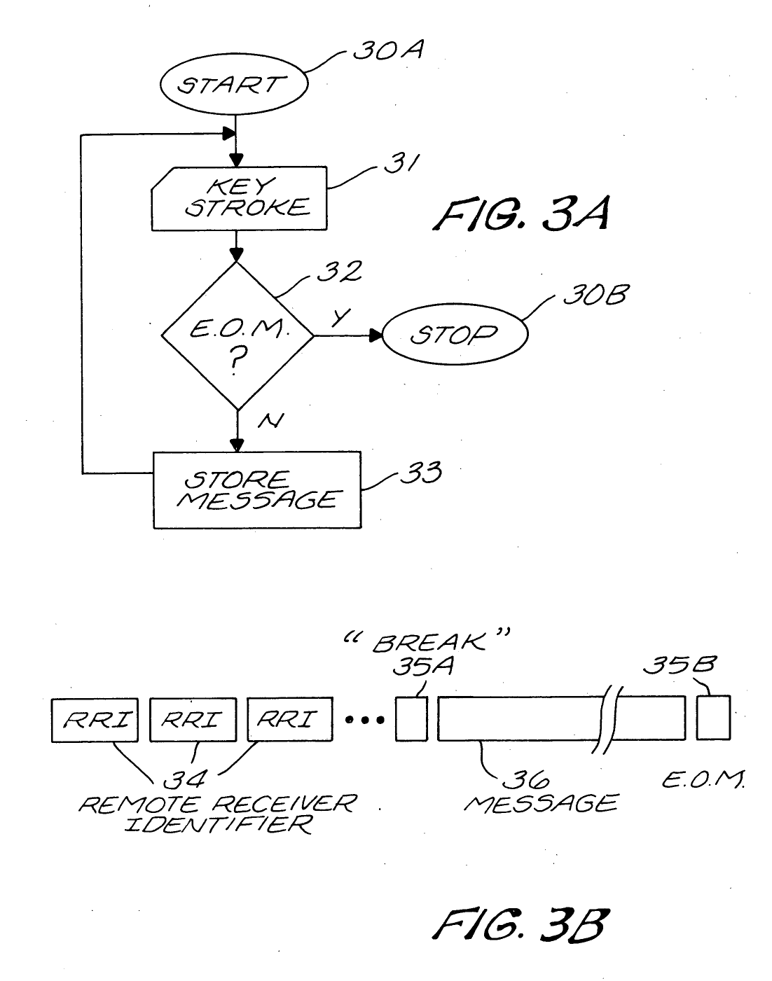

The message system 15 has stored therein the user-defined message together with at least one user-defined remote receiver identifier. Creation of the user-defined message and the remote receiver identifiers is made by operator 11A which is described in more detail relative to FIGS. 3A and 3B.

When operator 11A activates the message system 15 via message button 12A, message system 15 obtains the indicia from the GPS receiver 13, incorporates this indicia (or representation thereof) into the user-defined message, and sends the completed message, together with the user-defined remote receiver identifiers, to the communications mechanism 14.

The communications mechanism 14 communicates the completed message to the locations associated with the user-defined remote receiver identifiers via radio transmission 16.

Now referring to FIG. 1B, operator 11B holds the communications apparatus 10B which includes keyboard 18, screen 17, and message button 12B.

Screen 17 is used for operator prompt, to display the user-defined message (while it is being created and for editing purposes), and to display the user-defined remote receiver identifiers.

In this illustration, keyboard 18 is a simple numeric keypad, but, in the preferred embodiment of the invention, a “QWERTY” keyboard is provided to facilitate operator entry of data.

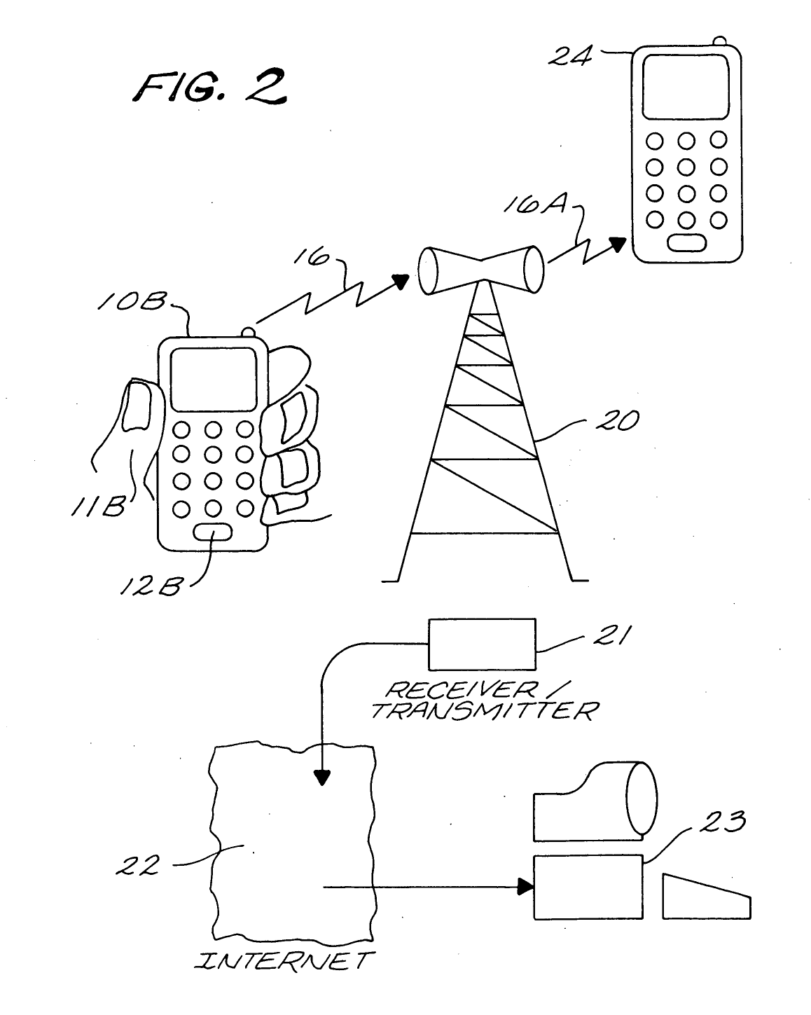

FIG. 2 graphically illustrates the components of the system of which the portable communications apparatus interacts.

Operator 11B, as described above, has created a message and destination within the memory of communications apparatus 10B. Later, when operator 11B activates the messaging system via button 12B, the message and location are sent to the designated destinations via radio waves 16.

Receiver/Transmitter 20 receives radio waves 16 and identifies the destinations associated with the message/GPS coordinates. In one situation, the message/GPS coordinates are sent by receiver/transmitter 20 via radio waves 16A to another communications apparatus 24. As in the above example, this communications apparatus 24 will receive the message:
“Dad, had car trouble. Please come. I'm at 1234 Main Street, Tucson, Ariz.”
   and be able to respond accordingly.

In this illustration, the destinations associated with the message/location received by receiver/transmitter 20 include an e-mail address for computer 23. In this instance, the message/GPS coordinates are sent from computer 21 connected to the receiver/transmitter 20, via Internet 22 to computer 23.

Computer 23 may also be associated with a friend or family of operator 11B; but, in some situations, computer 23 also includes service providers such as an automobile servicing agency, or an emergency provider.

In the case of the emergency provider such as a fire department, operator 11B may be an off-duty fireman who wants to instantly report a fire, in this case, the message/location could read:
“Smoke or Fire has been seen at 1234 Main Street, Tucson, Ariz.”

Some embodiments of the invention provide mapping functions which optionally include driving instructions from computer 23 to the location of communications apparatus 10B. In some embodiments, this map generating function is accomplished at communications apparatus 10B and is included in the message; in other embodiments, computer 21 performs this function.

FIGS. 3A and 3B is a flowchart and message structure for the creation of the stored message string within the portable communications apparatus.

In creating the data for memory, in this embodiment, as shown in FIG. 3A, once the program has started 30A, the key stroke into the communications apparatus is accepted 31. A determination is then made on if the key stroke is an End Of Message 32; if it is, then the program stops 30B.

If the key stroke is not an End Of Message (“EOM”)32, then the keystroke is stored in the message. In this manner, the operator, whether using a numeric pad or a QWERTY keypad, is able to create the stored message and destinations.

This embodiment uses the structure within memory as indicated by FIG. 3B for the message and destinations. The string of characters has as a first grouping the Remote Receiver Identifiers 34 which can be of any length or number as defined by the user. A “break” 35A denotes the end of the Remote Receiver Identifiers 34 and the beginning of the message 36.

The length of the message, and its content, is defined by the user and is terminated by an End Of Message 35B.

In this manner, the user is able to store the core message together with the destinations for the message prior to ever having to use it. The time period before the message's storage and its use can vary from tens of minutes to days. As example, a care-giver for an elderly person could establish the following message on their phone which could be activated if the elderly person “wanders off”:
“Mr. John Smith has been located at 9980 Elm Street.”

In this scenario, the user who establishes the message is the care-giver, and the user who activates the message is the person who “finds” Mr. Smith wandering the streets. In this manner, the authorities (i.e. Police), upon finding a confused Mr. Smith on the street is able to alert the care-giver to come and help with him.

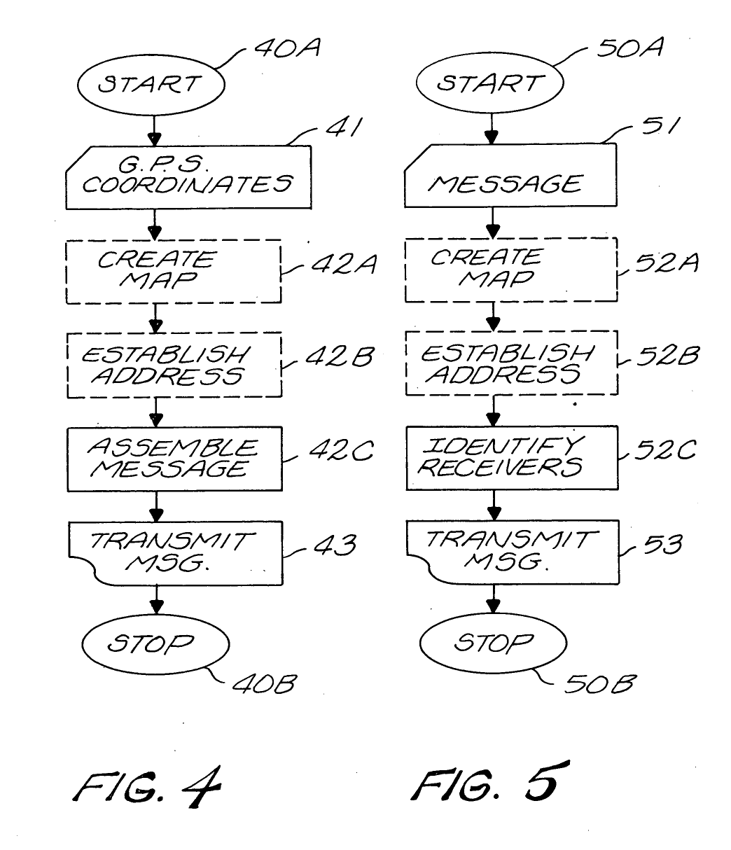

FIG. 4 is a flowchart of the operation of the preferred messaging system for the portable communications apparatus.

Once the activation button has been initiated for the message to be sent to the proper destinations, the program starts 40A and obtains the proper GPS coordinates 41. In some embodiments, these GPS coordinates are used to create a map 42A and/or to establish the approximate address 42B where the portable communications apparatus is located.

The message is the obtained from memory and assembled with the location or the map, or the address (depending on the user's choice).

The completed message is then transmitted to the identified destinations 43 and the program stops 40B.

In this manner, the user is not required to do anything other than press the single activation button; the message and location is sent out automatically.

FIG. 5 is a flowchart of the operation of the receiver/transmitter of the preferred embodiment.

The program starts 50A and receives the message and location from the portable communications apparatus. In some embodiments, the location within the message includes the GPS coordinates which are then used to create a map 52A and/or an approximate address 52C, which are combined with the message.

The destinations for the message or receivers are identified 52C and the completed message is transmitted 53 to these designated receivers. The program then stops 50B.

It is clear that the present invention provides for an easy to use and user configurable emergency call capability.

What is claimed is:

1. A portable communications apparatus comprising:
a) a global-positioning-receiver generating a location indicia of a location of the portable communications apparatus;
b) a communications system capable of sending a message to a user-defined remote receiver;
c) a messaging system having,
1) a user-defined message,
2) at least one user-defined remote receiver identifier, and,
3) location identifiers employing the location indicia; and,
wherein, when said messaging system is activated by a user of the portable communications apparatus, via the communications system, the user-defined message and the location identifiers are sent to a destination associated with each of the at least one user-defined remote receiver identifier.

2. The portable communications apparatus according to claim 1:
a) further including a memory; and,
b) wherein said user-defined message and the at least one user-defined remote receiver identifier are stored in said memory at least one day prior to said messaging system being activated by a user.

3. The portable communications apparatus according to claim 1, wherein said at least one user-defined remote receiver identifiers includes an emergency agency identifier.

4. The portable communications apparatus according to claim 1,
a) further including a mapping system employing the location indicia and generating a current position map therefrom; and,
b) wherein said messaging system, when activated by a user, includes said current position map.

5. The portable communications apparatus according to claim 4, wherein said mapping system also includes an approximate address for the location indicia.

6. The portable communications apparatus according to claim 5, further including a single user-activated button for activating said messaging system.

7. The portable communications apparatus according to claim 5, wherein said messaging system is activated when a user activates a 9-1-1 call.

8. A cellular telephone comprising:
a) a global-positioning-receiver generating a location indicia of a location of the portable communications apparatus; and,
b) a messaging system having,
1) a user-defined message,
2) a user-defined remote receiver identifier, and,
3) location identifiers employing the location indicia; and,
wherein, when said messaging system is activated by a user of the portable communications apparatus, the user-defined message and the location identifiers are formed into a status message and sent to a destination associated with the user-defined remote receiver identifier.

9. The cellular telephone according to claim 8,
a) further including a mapping system employing the location indicia and generating a current position map therefrom; and,
b) wherein the status message includes said current position map.

10. The cellular telephone according to claim 9,
a) wherein said mapping system also includes an approximate address for the location indicia; and,
b) wherein the approximate address is included in the status message.

11. A portable communications system comprising:
a) a receiving/transmitting apparatus configured to receive messages from a first remote apparatus and transmit messages to a second remote apparatus;
b) a receiving unit configured to receive messages from the receiving/transmitting apparatus; and,
c) a transmitting unit being portable and configured to transmit messages to the receiving/transmitting apparatus, said transmitting unit having,
1) a global-positioning-receiver generating a location indicia indicative of a location of the transmitting unit, and,
2) a messaging system, when activated, communicating, via the receiving/transmitting apparatus, a status message having the location indicia to the receiving unit.

12. The portable communications system according to claim 11, wherein the transmitting unit includes a single user-activated button for activating said messaging system.

13. The portable communications system according to claim 12, wherein the status message includes a user-defined text message.

14. The portable communications system according to claim 13,
a) wherein the transmitting unit further includes a mapping system employing the location indicia and generating a current position map therefrom; and,
b) wherein the status message includes the current position map.

15. The portable communications system according to claim 12, wherein the receiving/transmitting apparatus includes:
a) a memory having a text message stored therein, said text message being previously defined by a user of the transmitting unit; and,
b) a message modifying system adapted to add the text message from the memory to the status message prior to being sent to the receiving unit.

16. The portable communications system according to claim 15, wherein the receiving/transmitting apparatus;
a) further includes a mapping system employing the location indicia from the transmitting unit and generating a current position map therefrom; and,
b) wherein the message modifying system includes the current position map in the status message a status message prior to the status message being sent to the receiving unit.
